(19) United States
(12) Patent Application Publication
(10) Pub. No.: US 2007/0007272 A1
(43) Pub. Date: Jan. 11, 2007

(54) Elevated vertical oven

(76) Inventors: Massaco Simoyama Napoli, Sao Paulo (BR); Rodolfo Napoli, Sao Paulo (BR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/478,724

(22) Filed: Jul. 3, 2006

(30) Foreign Application Priority Data
Jul. 6, 2005 (BR) MU850.1282-3

(51) Int. Cl. A21B 1/22; A21B 1/00; F27D 11/00

(52) U.S. Cl. 219/400

(57) ABSTRACT

An ELEVATED VERTICAL OVEN constructed in a vertical box (1), mounted above the floor or partially leveled, having the entrance in the left side with bipartite door (2) and the exit in the right side with bipartite door (3). It has the upper part formed by two longitudinal parts (4) separated by a central fissure (5) in all its extension, where along such central fissure (5) a load sustaining set slides. The oven has a joist (6) integrated with an upper transversal metal plate for support (7) and a lower transversal metal plate (8) for guiding and reducing temperature loss. There is an upper prolongation (9) provided with a bore (10) and a lower prolongation (11) in which support rods (12) of the load are linked, in which ends have a support (13) integrated for the load. There are burners (14) installed defining the heating system actuating around the part under treatment; and where the upper prolongation (9) is provided with a bore (10) is used to elevate and transport load through cut and motorized trolley.

### BACKGROUND OF THE INVENTION

### Field of the Invention

The present patent of Utility Model refers to an Elevated Vertical Oven, for thermally treating metallic parts, with a modern conception and provided with important technical and functional improvements, in accordance with the most advanced Engineering concepts and in compliance with required rules and specifications, and which extraordinarily differs from conventional ovens due to its constructive arrangement and functioning, thus fully meeting the proposed objectives and provided of a series of technical and efficient advantages, its characteristics being novel in the art.

### SUMMARY OF THE INVENTION

The elevated oven has a construction in vertical box. It is mounted upper relative to the floor or partially leveled in an aperture in the floor, depending on the height of the building housing this installation.

The load (part to be treated) entrance is done through the left side and the exit is done through the right side. The upper part of the oven is separated in two longitudinal portions by a small aperture along which a device sustaining the load is dislocated.

The entrance and exit sides have bipartite doors, and when the left door is opened, it allows load to enter inside the oven, being hung over the upper part in two portions.

The heating, the degree, temperature and time to confirm the load soaking are preceded. The right door is opened and the load is lifted so that it can be transferred to outside the oven, after which cooling in calm air, ventilated air, oil, polymer or brine is performed.

The right door is closed, i.e., the exit door, the left side is opened and a new cycle is performed.

The heating system is formed by burners in both sides of the load. To serve the treatment to normalize 2440×6000 metal sheets, it is recommended that the oven has the following inner dimensions: 1500×3000×7000 mm.

A constructive variant of the elevated vertical oven, when it is used in an isolated fashion (not pertaining to a production line), may function with only one door instead of two. Such door allows both functions: for entrance and exit of the treated load, i.e., load entrance and exit are performed through one single door.

The elevated vertical oven of the present invention shall be better understood by reading the following detailed description and by observing the amended illustrative drawings, which is included herein by reference for a better explanation of the of the description.

### BRIEF DESCRIPTION OF THE DRAWINGS

FIG. 1: depicts a perspective view of the elevated vertical oven.

FIG. 2: depicts a sectioned view according to a plane indicated by line AA in the previous Figure.

FIG. 3: depicts a sectioned view according to a plane indicated by line BB in FIG. 1.

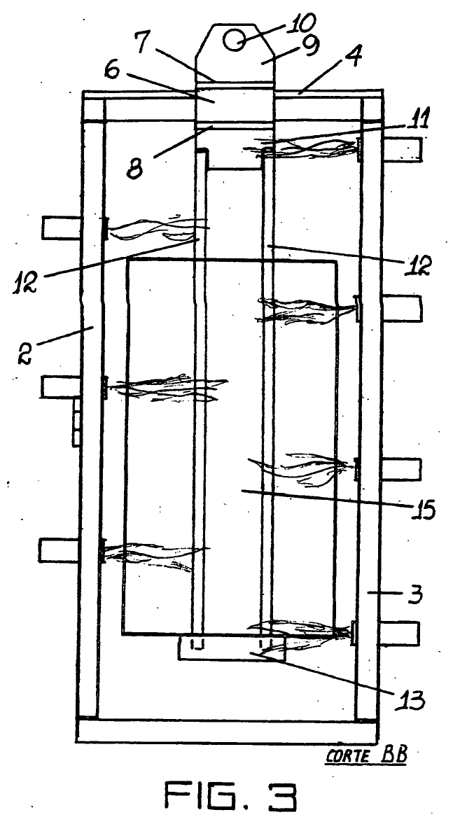

FIG. 4: depicts an inner upper view of the oven showing the route of the part under treatment relative to the oven.

FIG. 5: depicts a perspective view of the constructive variant of the elevated vertical oven.

FIG. 6: depicts a sectioned view according to a plane indicated by line C-C in FIG. 5.

FIGS. 7, 8 and 9: depicts an inner upper view of the oven showing the route of the part under treatment relative to the oven.

### DETAILED DESCRIPTION OF THE PREFERRED EMBODIMENTS

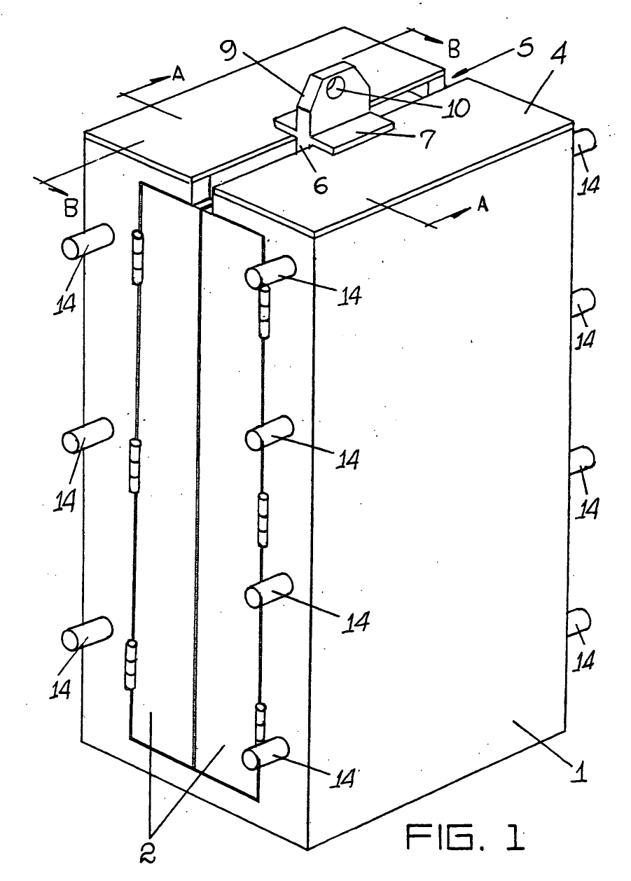

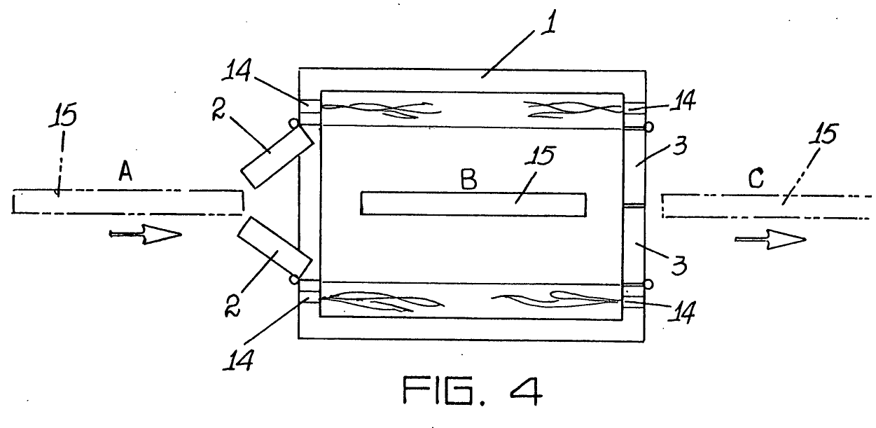

In accordance with FIGS. 1 and 4, the elevated vertical oven herein proposed is comprised of a construction in vertical box (1), mounted above the floor or partially leveled, having the entrance in the left side with bipartite door (2) and the exit in the right side with bipartite door (3).

The upper part is formed by two longitudinal parts (4) separated by a central fissure (5) in all its extension.

Along such central fissure (5) a load sustaining set slides, comprised of a joist (6) integrated with an upper transversal metal plate for support (7) and a lower transversal metal plate (8) for guiding and reducing temperature loss, and having an upper prolongation (9) provided with a bore (10) and a lower prolongation (11) in which support rods (12) of the load are linked, in which ends have a support (13) integrated for the load, wherein the support means may be a “housing” type or another.

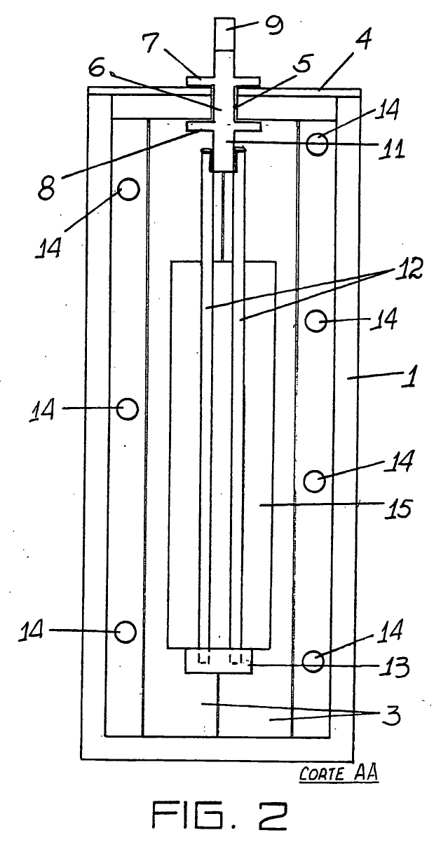

A joist (6) is fitted in central fissure (5) with an upper transversal metal plate (7) supported over the upper portion surface and the lower transversal metal plate (8) put under the sustaining joist of the upper portion, as seen in FIG. 2. Thus arranged, the load sustaining set slides along central fissure (5) of the upper portion (4), so as to perform the transport of the part inside the oven. The upper prolongation (9) provided with a bore (10) is used to elevate and transport load through cut and motorized trolley to optimize the transportation.

In both inner sides of the oven there are burners (14) installed defining the heating system actuating around the part under treatment.

FIG. 4 shows an exemplary functioning of the elevated vertical oven. Once left doors are open (2), the part to be treated (15-A) is introduced into the oven. These doors (2) are opened and the process of thermal treatment of said part (15-B) which is involved in the temperature produced by burners (14). After processing, the right doors are open (3) and the treated part (15-C) is removed from inside the oven, being transported by the cut to refrigeration place. The right doors (3) are closed and the left doors are opened (2), thus initiating a new processing cycle, and then successively.

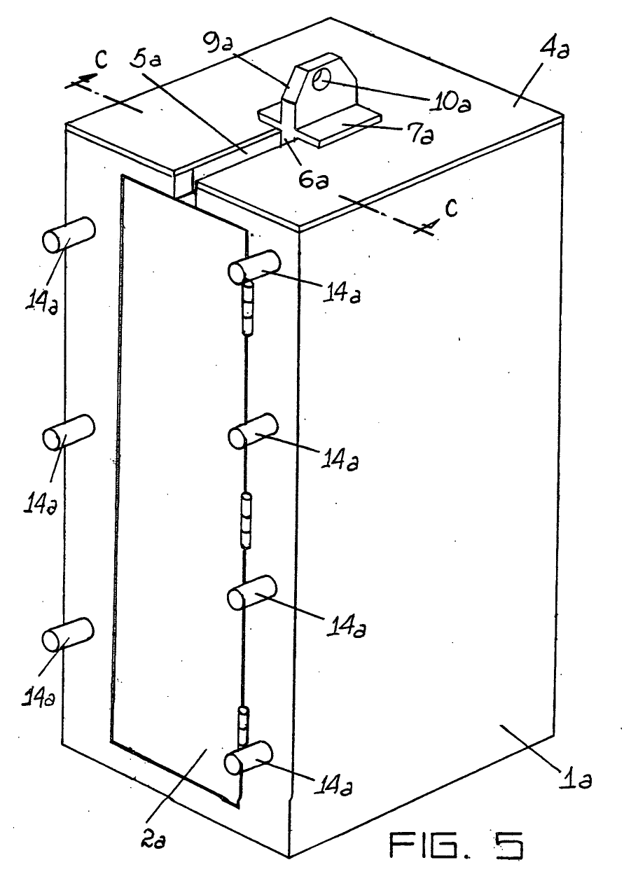

A constructive variation of the elevated vertical oven is illustrated in FIGS. 5, 6, 7, 8, and 9.

As referred in these Figures, the elevated vertical oven (1a) is provided with a single access, with one single laterally jointed door (2a). Through such single access the load (part to be treated) entrance and load (treated part) exit are performed. The upper portion (4a) of the oven is provided with a central fissure (5a) extending from half the oven, along which the load sustaining set slides, comprised of a joist (6a) integrated with an upper transversal metal plate for support (7a) and a lower transversal metal plate (8a) for guiding and reducing temperature loss, and having an upper prolongation (9a) provided with a bore (10a) and a lower prolongation (11a) in which support rods (12a) of the load are linked, in which ends have a support (13a) integrated for the load, wherein the support means may be a “housing” type or another.

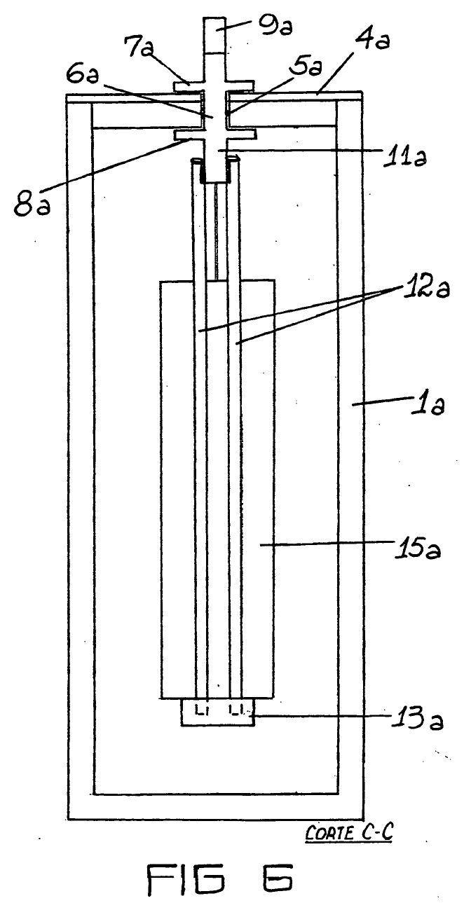

The joist (6a) is fitted in central fissure (5a) with an upper transversal metal plate (7a) supported over the upper portion surface and the lower transversal metal plate (8a) put under the sustaining joist of the upper portion, as seen in FIG. 6. Thus arranged, the load sustaining set slides along central fissure (5a) of the upper portion (4a), so as to perform the transport of the part inside the oven.

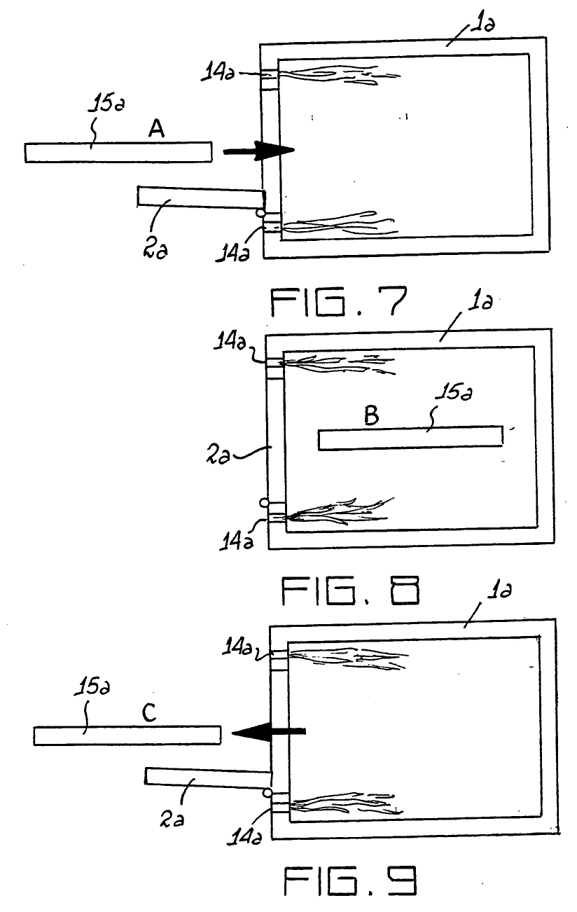

In the side where the single door is located there are burners (14a) installed defining the heating system actuating around the part under treatment. FIGS. 7, 8 and 9 show an exemplary functioning of a variation of the elevated vertical oven. Once left doors are open (2a-FIG. 7), the part to be treated (15a-A) is introduced into the oven. This door (2a) is closed and the process of thermal treatment of said part (15a-B) starts which is involved in the temperature produced by burners (14a-FIG. 8). After processing, the door (2a) is open and the treated part (1 a-C) is removed from inside the oven (FIG. 9), being transported by the cut to refrigeration place, thus initiating a new processing cycle, and then successively.

The procedure to treat the part is the same described for the oven with entrance and exit in two opposite sides and with bipartite doors, the only difference is that the load enters and exits through the same door.

What is claimed is:

1) “ELEVATED VERTICAL OVEN”, characterized by the fact it comprised of a construction in vertical box (1), mounted above the floor or partially leveled, having the entrance in the left side with bipartite door (2) and the exit in the right side with bipartite door (3); and it has the upper part formed by two longitudinal parts (4) separated by a central fissure (5) in all its extension, wherein along such central fissure (5) a load sustaining set slides, comprised of a joist (6) integrated with an upper transversal metal plate for support (7) and a lower transversal metal plate (8) for guiding and reducing temperature loss, and having an upper prolongation (9) provided with a bore (10) and a lower prolongation (11) in which support rods (12) of the load are linked, in which ends have a support (13) integrated for the load, wherein the support means may be a “housing” type or another; and the joist (6) is fitted in central fissure (5) with an upper transversal metal plate (7) supported over the upper portion surface and the lower transversal metal plate (8) put under the sustaining joist of the upper portion; and wherein both inner sides of the oven there are burners (14) installed defining the heating system actuating around the part under treatment; and wherein the upper prolongation (9) is provided with a bore (10) is used to elevate and transport load through cut and motorized trolley.

2) “ELEVATED VERTICAL OVEN”, in accordance with claim 1, characterized by a constructive variation wherein the elevated vertical oven (1a) is provided with a single access, with one single laterally jointed door (2a), wherein such single access the load (part to be treated) entrance is performed and load (treated part) exit; and wherein the upper portion (4a) of the oven is provided with a central fissure (5a) extending from half the oven, along which the load sustaining set slides, comprised of a joist (6a) integrated with an upper transversal metal plate for support (7a) and a lower transversal metal plate (8a) for guiding and reducing temperature loss, and having an upper prolongation (9a) provided with a bore (10a) and a lower prolongation (11a) in which support rods (12a) of the load are linked, in which ends have a support (13a) integrated for the load, wherein the support means may be a “housing” type or another; and wherein the joist (6a) is fitted in central fissure (5a) with an upper transversal metal plate (7a) supported over the upper portion surface and the lower transversal metal plate (8a) put under the sustaining joist of the upper portion; and wherein there are burners (14a) installed on the side where the single door is located, defining the heating system actuating around the part under treatment.

3. An elevated vertical oven comprising:
a housing having an first opening defining an entrance on one side and a second opening defining an exit on an opposite side thereof, each said openings having bipartite doors, said housing having an upper portion formed of two longitudinal parts separated by a central fissure;
a plurality of burners disposed on opposing inner surfaces of said housing;
a load sustaining set disposed in said central fissure being slidably displaceable therein, said load sustaining set including a joist, an upper prolongation and a lower prolongation, said joist having integrated upper and lower transverse metal plates, said upper prolongation having a bore used to elevate and transport load through cut and motorized trolley to optimize transport, said lower prolongation having a set of support rods with an integrated support at an end thereof,
wherein said joist being disposed in said central fissure with said upper transverse metal plate supported above said upper portion and said lower transverse metal plate disposed below said joist thereby providing for slidable displacement of said load sustaining set.

4. An elevated vertical oven comprising:
a housing having an opening on one side thereof;
a door being coupled to said housing and covering said opening;
a central fissure formed in a portion of an upper surface of said housing;
a plurality of burners disposed on opposing inner surfaces of said housing;
a load sustaining set disposed in said central fissure being slidably displaceable therein, said load sustaining set including a joist, an upper prolongation and a lower prolongation, said joist having integrated upper and lower transverse metal plates, said upper prolongation having a bore used to elevate and transport load through cut and motorized trolley to optimize transport, said lower prolongation having a set of support rods with an integrated support at an end thereof,
wherein said joist being disposed in said central fissure with said upper transverse metal plate supported above said upper portion and said lower transverse metal plate disposed below said joist thereby providing for slidable displacement of said load sustaining set.
